(19) United States
(12) Patent Application Publication
(10) Pub. No.: US 2026/0104300 A1
(43) Pub. Date: Apr. 16, 2026

(54) PRESSURE SENSOR

(71) Applicants: HYUNDAI MOTOR COMPANY, Seoul (KR); Kia Corporation, Seoul (KR); AMOGREENTECH CO., LTD., Gimpo-si (KR)

(72) Inventors: Jang Hyeon LEE, Hwaseong-si (KR); Dong Gu KIM, Hwaseong-si (KR); Deok Woo YUN, Hwaseong-si (KR); Gwan Sik Kim, Hwaseong-si (KR); Kyong Hwa SONG, Hwaseong-si (KR); Seok Min LEE, Hwaseong-si (KR); Yun Mi SO, Incheon (KR); Geun Young JANG, Gimpo-si (KR); In Yong SEO, Seoul (KR)

(21) Appl. No.: 19/244,160

(22) Filed: Jun. 20, 2025

(30) Foreign Application Priority Data
Oct. 11, 2024 (KR) 10-2024-0138952

(51) Int. Cl. G01L 1/18; G01L 1/26

(52) U.S. Cl. CPC G01L 1/18; G01L 1/26

(57) ABSTRACT

A pressure sensor includes a first substrate, a second substrate arranged parallel to the first substrate, a first electrode disposed between the first substrate and the second substrate and in contact with the first substrate, a second electrode disposed between the first substrate and the second substrate and in contact with the second substrate, a first sensing layer that is connected to the first electrode and the second electrode and has a first resistance configured to change responsive to a pressure or a temperature transmitted from the first substrate or the second substrate, a second sensing layer that is connected to the first electrode and has a second resistance configured to change responsive to the temperature, and a third electrode that is in contact with one surface of the second sensing layer, faces the second substrate, and is spaced apart from the second substrate.

### CROSS-REFERENCE TO RELATED APPLICATION

This application claims the benefit of priority to Korean Patent Application No. 10-2024-0138952, filed in the Korean Intellectual Property Office, on Oct. 11, 2024, the entire contents of which are incorporated herein by reference.

### TECHNICAL FIELD

The present disclosure relates to a pressure sensor.

### BACKGROUND

A sensor is a device for sensing a temperature, a pressure, or the like of a separate object. In particular, the sensor for sensing a pressure of a battery cell or the like may be classified into a pressure sensor for measuring a strain of the battery cell or the like or a pressure sensor for measuring a pressure of the battery cell or the like.

In some cases, the pressure sensor for measuring the pressure of the battery cell or the like may be classified into a load cell method or a force sensitive resistor (FSR) method, but in the load cell method, a relatively large volume may be occupied, and thus there may be a limitation in space.

In the case of the FSR, the form of a thin film may be provided, the form of being attached to a surface of the battery cell may be provided, and thus it may be advantageous for light weight and miniaturization. In particular, the FSR may accurately measure swelling of the battery cell and thus may be used as a pressure sensor for measuring the pressure of the battery cell.

In some cases, a piezoelectric sensor may be a resistive sensor. In some cases, where an electrical resistance value of the piezoelectric sensor changes according to a change in a temperature or an ambient temperature of the battery cell, a pressure value of the battery cell may be compensated according to the change in the temperature or the ambient temperature of the battery cell.

### SUMMARY

The present disclosure describes a pressure sensor capable of compensating for a pressure value according to a temperature without a separate temperature sensor.

According to one aspect of the subject matter described in this present disclosure, a pressure sensor includes a first substrate, a second substrate arranged parallel to the first substrate, a first electrode disposed between the first substrate and the second substrate and in contact with the first substrate, a second electrode disposed between the first substrate and the second substrate and in contact with the second substrate, a first sensing layer connected to the first electrode and the second electrode, the first sensing layer having a first resistance configured to change in response to at least one of a pressure or a temperature that is transmitted from the first substrate or the second substrate, a second sensing layer connected to the first electrode, the second sensing layer having a second resistance configured to change in response to the temperature, and a third electrode that is in contact with one surface of the second sensing layer, the third electrode facing the second substrate and being spaced apart from the second substrate.

Implementations according to this aspect can include one or more of the following features. For example, the pressure sensor can include a processor electrically connected to the first electrode, the second electrode, and the third electrode, where the processor is configured to calculate a difference between (i) a first potential difference between the first electrode and the second electrode sensed by the first sensing layer and (ii) a second potential difference between the first electrode and the third electrode sensed by the second sensing layer, and based on the difference between the first potential difference and the second potential difference, determine a pressure applied to the first substrate or the second substrate.

In some implementations, the first substrate and the second substrate can be spaced apart from each other in a first direction, where the first sensing layer is disposed outside the second sensing layer in a second direction intersecting the first direction.

In some examples, the second electrode can include an open area facing the third electrode and an electrode area disposed outside the open area in the second direction.

In some examples, the electrode area can surround the open area.

In some implementations, the second electrode can include an inner electrode area facing the third electrode and an outer electrode area disposed outside the inner electrode area in the second direction.

In some examples, the inner electrode area and the outer electrode area can be connected to each other in the second direction.

In some examples, the third electrode can be configured to come into contact with the inner electrode area based on receiving the pressure exceeding a predetermined pressure range from the first substrate or the second substrate.

In some implementations, the pressure sensor can include a processor electrically connected to the first electrode, the second electrode, and the third electrode, where the processor is configured to transmit notification information to a user based on the third electrode contacting the inner electrode area.

In some implementations, a rate of change of the first resistance of the first sensing layer in response to the temperature can be equal to a rate of change of the second resistance of the second sensing layer in response to the temperature.

In some implementations, an initial value of the first resistance of the first sensing layer can be equal to an initial value of the second resistance of the second sensing layer.

In some implementations, the first substrate and the second substrate can be spaced apart from each other in a first direction, where the first electrode, the second electrode, and the first sensing layer are arranged in a space between the first substrate and the second substrate and stacked in the first direction.

In some examples, the first electrode, the second electrode, and the first sensing layer are configured to seal a periphery of the space between the first substrate and the second substrate.

In some implementations, the second sensing layer can be disposed between the first electrode and the third electrode in the first direction, where the third electrode is configured to be spaced apart from the second substrate in the first direction.

In some examples, the third electrode is configured to, in response to the at least one of the pressure or the temperature, contact the second substrate in the first direction.

In some implementations, the second sensing layer and the third electrode can be configured to be spaced apart from the first sensing layer in a second direction intersecting the first direction, where the first sensing layer is configured to, in response to the at least one of the pressure or the temperature, expand in the second direction and contact at least one of the second sensing layer or the third electrode.

In some implementations, the first substrate and the second substrate can be made of polyimide or polyethylene terephthalate, and the first electrode, the second electrode, and the third electrode can be made of gold, platinum, silver, or copper.

In some examples, the first sensing layer and the second sensing layer can include conductive particles and a polymer binder.

### BRIEF DESCRIPTION OF THE DRAWINGS

FIG. 1 is a plan view illustrating an example of a pressure sensor.

FIG. 2 is a plan view illustrating an example of a second substrate, a first sensing layer, a second sensing layer, and a third electrode of the pressure sensor.

FIG. 3 is a vertical cross-sectional view of the pressure sensor.

FIG. 4 is a vertical cross-sectional view of the pressure sensor, to which a pressure is applied.

FIG. 5 is a vertical cross-sectional view illustrating an example of a pressure sensor.

FIG. 6 is a vertical cross-sectional view of the pressure sensor of FIG. 5, to which a pressure is applied.

### DETAILED DESCRIPTION

Hereinafter, one or more implementations of the present disclosure will be described in detail with reference to the example drawings. In adding reference numerals to components of each drawing, it should be noted that identical or equivalent components are designated by an identical numeral even when they are displayed on other drawings. Further, in describing the implementation of the present disclosure, a detailed description of the related known configuration or function will be omitted when it is determined that the detailed description interferes with the understanding of the implementation of the present disclosure.

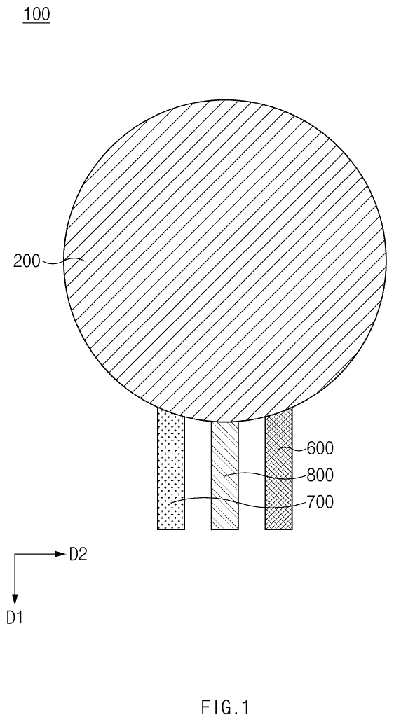

Hereinafter, one or more implementations of the present disclosure will be described in detail with reference to FIGS. 1 to 6. Hereinafter, a direction D1, a direction D2, and a direction D3 can be perpendicular to each other.

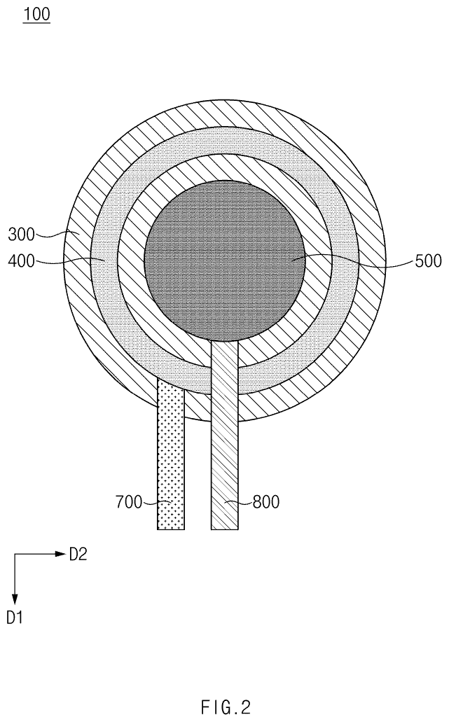

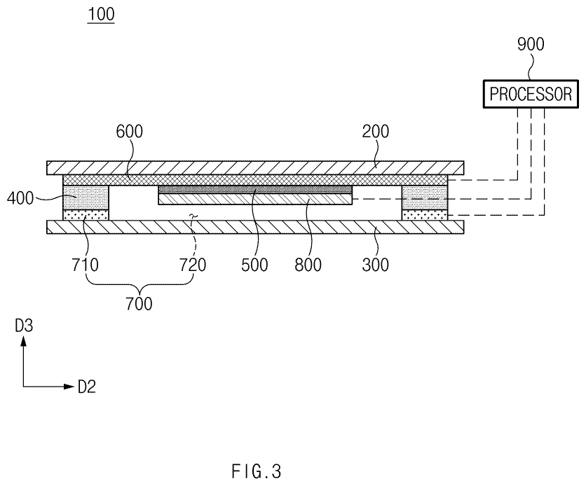

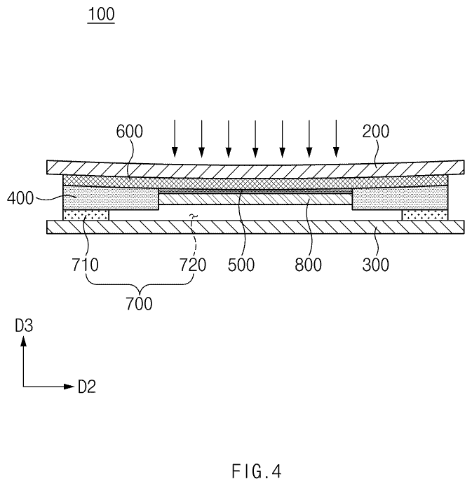

FIG. 1 is a plan view showing an example of a pressure sensor. FIG. 2 is a plan view showing an example of a second substrate, a first sensing layer, a second sensing layer, and a third electrode of the pressure sensor. FIG. 3 is a vertical cross-sectional view of the pressure sensor. FIG. 4 is a vertical cross-sectional view of the pressure sensor, to which a pressure is applied.

Referring to FIGS. 1 to 4, in some implementations, a pressure sensor 100 can include a first substrate 200, a second substrate 300, and a first sensing layer 400, a second sensing layer 500, a first electrode 600, a second electrode 700, and a third electrode 800, which are arranged between the first substrate 200 and the second substrate 300.

The pressure sensor 100 can be a pressure sensor driven in a Force Sensitive Resistor (FSR) method. The pressure sensor 100 can be a device for measuring a pressure applied through the first substrate 200 or the second substrate 300. As an example, the pressure sensor 100 can be a device for measuring a pressure of a battery cell attached to the first substrate 200 or the second substrate 300, but the present disclosure is not limited thereto.

In particular, in the case of the pressure sensor for measuring the pressure of the battery cell, since the pressure sensor 100 uses the FSR method, miniaturization is possible, and space utilization is advantageous.

The first substrate 200 and the second substrate 300 can be arranged parallel to each other in the direction D3. A pressure measurement object can be in contact with at least one of the first substrate 200 and the second substrate 300. In some cases, the direction D3 can be referred to as a first or third direction intersecting the second direction D2.

When a pressure is applied to the first sensing layer 400 and the second sensing layer 500, a resistance can be changed. For this reason, the pressure sensor 100 can be an FSR piezoelectric sensor. The sensing layers 400 and 500 of the pressure sensor 100 can be affected by a change in a temperature of the object or an ambient temperature in addition to a pressure applied from the object.

As an example, the sensing layers 400 and 500 of the pressure sensor 100 can have a resistance value that changes depending on whether the pressure of the object remains unchanged or whether the temperature of the object or the ambient temperature changes in addition to the pressure of the object. In order to more accurately measure the pressure of the object, the pressure sensor 100 can be configured to compensate for a resistance change value according to the temperature.

In some implementations, unlike an example having a separate temperature sensor, the pressure sensor 100 can include the second sensing layer 500 and the third electrode 800 so that the resistance changes only according to the temperature.

In more detail, the first electrode 600 can be disposed between the first substrate 200 and the second substrate 300 and can be in contact with the first substrate 200. The second electrode 700 can be disposed between the first substrate 200 and the second substrate 300 and can be in contact with the second substrate 300.

The first sensing layer 400 can be disposed between the first electrode 600 and the second electrode 700 and can be connected to the first electrode 600 and the second electrode 700. The first sensing layer 400 can be disposed between the first electrode 600 and the second electrode 700. The first sensing layer 400 can generate a potential difference between the first electrode 600 and the second electrode 700.

The first sensing layer 400 can be formed such that a resistance thereof changes due to a pressure transmitted from the first substrate 200 or the second substrate 300.

The first sensing layer 400 can be formed such that resistance thereof changes due to a temperature in addition to the pressure transmitted from the first substrate 200 or the second substrate 300. Accordingly, the pressure sensor 100 can be configured to exclude a change in a resistance according to a change in a temperature from a change in a resistance according to changes in a pressure and a temperature sensed by the first sensing layer 400.

For example, the second sensing layer 500 having a resistance that changes only according to the temperature can be provided to be in contact with the first electrode 600 but not in contact with the second electrode 700.

An initial resistance value of the first sensing layer 400 can be the same as an initial resistance value of the second sensing layer 500. Further, a temperature coefficient of resistance (TCR) of the first sensing layer 400 can be the same as the TCR of the second sensing layer 500. That is, a rate of change in the resistance according to the temperature of the first sensing layer 400 can be the same as a rate of change in the resistance according to the temperature of the second sensing layer 500.

That is, the second sensing layer 500 can be in contact with the third electrode 800 and the first electrode 600 arranged to be spaced apart from the second substrate 300 in the direction D3. The second sensing layer 500 can be disposed between the first electrode 600 and the third electrode 800 and can generate a potential difference between the first electrode 600 and the third electrode 800.

The third electrode 800 can be in contact with one surface of the second sensing layer 500 facing the second substrate 300 and can be disposed to be spaced apart from the second substrate 300. Accordingly, the resistance of the second sensing layer 500 may not be changed by the pressure transmitted from the first substrate 200 or the second substrate 300.

The pressure sensor 100 can further include a processor 900 electrically connected to the first electrode 600, the second electrode 700, and the third electrode 800. The processor 900 can calculate a difference between a first potential difference between the first electrode 600 and the second electrode 700 due to the first sensing layer 400 and a second potential difference between the first electrode 600 and the third electrode 800 due to the second sensing layer 500. For example, the processor 900 can include an electric circuit, a microchip, an integrated circuit, a computer, a terminal, a microprocessor, etc.

The processor 900 can calculate the pressure transmitted to the first substrate 200 or the second substrate 300 through the difference between the first potential difference between the first electrode 600 and the second electrode 700 due to the first sensing layer 400 and the second potential difference between the first electrode 600 and the third electrode 800 due to the second sensing layer 500.

The first potential difference between the first electrode 600 and the second electrode 700 due to the first sensing layer 400 can be a potential difference due to both a change in resistance according to a change in temperature and a change in resistance according to the pressure transmitted from the first substrate 200 or the second substrate 300.

Further, the second potential difference between the first electrode 600 and the third electrode 800 due to the second sensing layer 500 can be a potential difference due to the change in resistance according to the change in temperature. Thus, a value obtained by subtracting the second potential difference from the first potential difference can be a potential difference according to a pure pressure applied to the pressure sensor 100. The processor 900 can calculate the pressure applied to the pressure sensor 100 through the difference between the first potential difference and the second potential difference.

For example, a circuit for removing a difference between the change in resistance according to the first sensing layer 400 and the change in resistance of the second sensing layer 500 can be provided as a Wheatstone bridge circuit or a circuit for distributing the potential difference, but the present disclosure is not limited thereto.

In some examples, the processor 900 can be configured to determine the first potential difference by the first sensing layer, determine the second potential difference by the second sensing layer 500, and determine the difference between the first potential difference and the second potential difference.

In some implementations, as illustrated in FIGS. 1 and 2, the first substrate 200 and the second substrate 300 can include a circular shape when viewed in a state of being spaced apart from each other in the direction D3. However, the present disclosure is not limited thereto. For example, in some cases, the first substrate 200 and the second substrate 300 can include a quadrangular shape or the like.

Further, the first sensing layer 400 can be disposed outside the second sensing layer 500 in direction D2 or a radial direction opposite to the direction D2. In other words, the second electrode 700 can be disposed outside the third electrode 800 in the radial direction.

The second electrode 700 can include an electrode area 710 and an open area 720. The open area 720 can be formed on an area of the second electrode 700 facing the third electrode 800 and can be an area between the second substrate 300 and the third electrode 800.

The electrode area 710 can be disposed outside the open area 720 in a radial outward direction of the pressure sensor 100. The open area 720 can be defined by being surrounded by the electrode area 710. Further, the electrode area 710 can extend to surround the open area 720 disposed inside the electrode area 710 in the radial direction.

According to this structure, the first electrode 600, the first sensing layer 400, and the second electrode 700 can support the first substrate 200 and the second substrate 300. The second sensing layer 500 and the third electrode 800 can be arranged inside the first sensing layer 400 and the electrode area 710 in the radial direction.

In some implementations, the pressure sensor 100 can be structurally stable as compared to a structure in which the second sensing layer 500 and the third electrode 800 are arranged outside the first sensing layer 400 and the electrode area 710 in the radial direction.

The first substrate 200 and the second substrate 300 can be made of polyimide or polyethylene terephthalate. The first electrode 600, the second electrode 700, and the third electrode 800 can be made of gold, platinum, silver, copper, or the like. In some examples, the first sensing layer 400 and the second sensing layer 500 can include a conductive particle, a polymer binder, or the like.

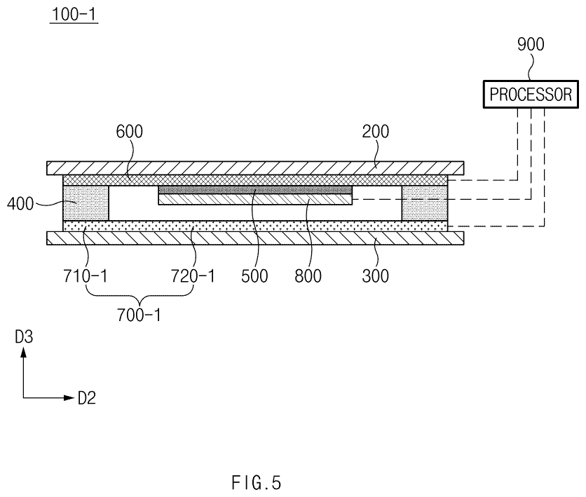

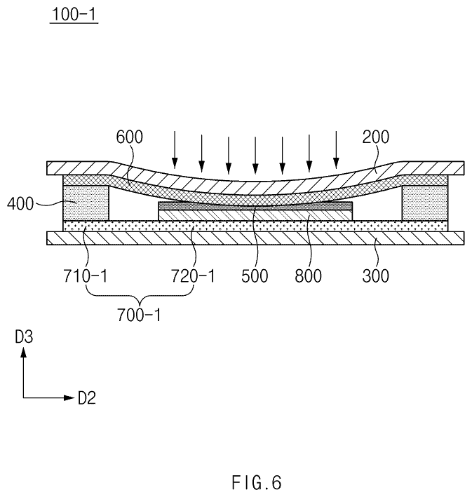

FIG. 5 is a vertical cross-sectional view showing an example of a pressure sensor. FIG. 6 is a vertical cross-sectional view of the pressure sensor of FIG. 5, to which a pressure is applied.

Referring to FIGS. 5 and 6, a pressure sensor 100-1 can include a second electrode 700-1 having a shape different from that of the second electrode 700 of the pressure sensor 100 of FIGS. 1 to 4. Other components except for the second electrode 700-1 among components of the pressure sensor 100-1 cite the description of the other components except for the second electrode 700 among the components of the pressure sensor 100.

In more detail, unlike the second electrode 700, the second electrode 700-1 can include an outer electrode area 710-1 and an inner electrode area 720-1. The inner electrode area 720-1 can be disposed between the third electrode 800 and the second substrate 300 and can be formed on an area facing the third electrode 800. The inner electrode area 720-1 can be disposed inside the outer electrode area 710-1 in the radial direction and connected to the outer electrode area 710-1.

The outer electrode area 710-1 can be disposed outside the inner electrode area 720-1 in the radial direction. The outer electrode area 710-1 can be a portion of the second electrode 700-1 disposed between the second substrate 300 and the first sensing layer 400. In this way, the outer electrode area 710-1 and the inner electrode area 720-1 can be connected to each other in the radial direction.

Before a pressure is applied to the pressure sensor 100-1, the inner electrode area 720-1 and the third electrode 800 can be spaced apart from each other in the direction D3. Further, even when a pressure within a predetermined pressure sensing range of the pressure sensor 100-1 is applied, the inner electrode area 720-1 and the third electrode 800 can be spaced apart from each other in the direction D3 even though the inner electrode area 720-1 and the third electrode 800 become closer to each other.

In some examples, as illustrated in FIG. 6, when a pressure exceeding the pressure sensing range of the pressure sensor 100-1 is applied, the third electrode 800 can come into contact with the inner electrode area 720-1.

In this case, since the second electrode 700-1 and the third electrode 800, which are separately provided, come into contact with each other, an unintended overcurrent flows, and the processor 900 can recognize the overcurrent. In this case, when the third electrode 800 comes into contact with the inner electrode area 720-1, the processor 900 can transmit notification information to a user.

In some examples, the user can know information that the pressure exceeding the predetermined pressure sensing range is applied to the object including the battery cell or the like, and the user can identify that the battery cell or the like is abnormal. Thus, the user can identify in advance that the battery cell or the like is abnormal, and thus safety can be improved.

The pressure sensor 100 or 100-1 can calculate a pure pressure applied to the pressure sensor 100 or 100-1 by excluding an effect on the resistance according to the change in temperature by only the first sensing layer 400 and the second sensing layer 500 without a separate temperature sensor.

For example, the pressure sensor 100 or 100-1 can be driven in a piezoresistive manner to improve usability and space utilization, and at the same time, to accurately measure the pressure by reducing a pressure error due to the temperature.

Further, when the pressure exceeding the pressure sensing range is applied to the pressure sensor 100-1, since the second electrode 700 and the third electrode 800 come into contact with each other, the user can check the contact, and thus safety can be improved.

According to the present technology, a pressure sensor can compensate for a pressure value according to a temperature with only a first sensing layer, a second sensing layer, a first electrode, a second electrode, and a third electrode without a separate temperature sensor, so that productivity of the pressure sensor can be improved.

In some implementations, a pressure sensor can be manufactured in the form of a thin film and thus miniaturization can be advantageous.

In some implementations, when a pressure exceeding a pressure sensing range of a pressure sensor is applied, a first electrode can come into contact with a second electrode, a danger state of a battery cell can be notified to a user, and thus safety can be improved.

In addition, various effects directly or indirectly identified though the present document can be provided.

The above description is merely illustrative of the technical spirit of the present disclosure, and those skilled in the art to which the present disclosure belongs can make various modifications and changes without departing from the essential features of the present disclosure.

Thus, the implementations disclosed in the present disclosure are not intended to limit the technology spirit of the present disclosure but are intended to describe the present disclosure, and the scope of the technical spirit of the present disclosure is not limited by these implementations. The scope of protection of the present disclosure should be interpreted by the appended claims, and all technical spirits within the scope equivalent thereto should be interpreted as being included in the scope of the present disclosure.

What is claimed is:

1. A pressure sensor comprising:
a first substrate;
a second substrate arranged parallel to the first substrate;
a first electrode disposed between the first substrate and the second substrate and in contact with the first substrate;
a second electrode disposed between the first substrate and the second substrate and in contact with the second substrate;
a first sensing layer connected to the first electrode and the second electrode, the first sensing layer having a first resistance configured to change in response to at least one of a pressure or a temperature that is transmitted from the first substrate or the second substrate;
a second sensing layer connected to the first electrode, the second sensing layer having a second resistance configured to change in response to the temperature; and
a third electrode that is in contact with one surface of the second sensing layer, the third electrode facing the second substrate and being spaced apart from the second substrate.

2. The pressure sensor of claim 1, further comprising:
a processor electrically connected to the first electrode, the second electrode, and the third electrode,
wherein the processor is configured to:
determine a difference between (i) a first potential difference between the first electrode and the second electrode sensed by the first sensing layer and (ii) a second potential difference between the first electrode and the third electrode sensed by the second sensing layer, and
based on the difference between the first potential difference and the second potential difference, determine a pressure applied to the first substrate or the second substrate.

3. The pressure sensor of claim 1, wherein the first substrate and the second substrate are spaced apart from each other in a first direction, and
wherein the first sensing layer is disposed outside the second sensing layer in a second direction intersecting the first direction.

4. The pressure sensor of claim 3, wherein the second electrode includes:
an open area facing the third electrode; and
an electrode area disposed outside the open area in the second direction.

5. The pressure sensor of claim 4, wherein the electrode area surrounds the open area.

6. The pressure sensor of claim 3, wherein the second electrode includes:
an inner electrode area facing the third electrode; and
an outer electrode area disposed outside the inner electrode area in the second direction.

7. The pressure sensor of claim 6, wherein the inner electrode area and the outer electrode area are connected to each other in the second direction.

8. The pressure sensor of claim 6, wherein the third electrode is configured to come into contact with the inner electrode area based on receiving the pressure exceeding a predetermined pressure range from the first substrate or the second substrate.

9. The pressure sensor of claim 6, further comprising:
a processor electrically connected to the first electrode, the second electrode, and the third electrode,
wherein the processor is configured to transmit notification information to a user based on the third electrode contacting the inner electrode area.

10. The pressure sensor of claim 1, wherein a rate of change of the first resistance of the first sensing layer in response to the temperature is equal to a rate of change of the second resistance of the second sensing layer in response to the temperature.

11. The pressure sensor of claim 1, wherein an initial value of the first resistance of the first sensing layer is equal to an initial value of the second resistance of the second sensing layer.

12. The pressure sensor of claim 1, wherein the first substrate and the second substrate are spaced apart from each other in a first direction, and
wherein the first electrode, the second electrode, and the first sensing layer are arranged in a space between the first substrate and the second substrate and stacked in the first direction.

13. The pressure sensor of claim 12, wherein the first electrode, the second electrode, and the first sensing layer are configured to seal a periphery of the space between the first substrate and the second substrate.

14. The pressure sensor of claim 12, wherein the second sensing layer is disposed between the first electrode and the third electrode in the first direction, and
wherein the third electrode is configured to be spaced apart from the second substrate in the first direction.

15. The pressure sensor of claim 14, wherein the third electrode is configured to, in response to the at least one of the pressure or the temperature, contact the second substrate in the first direction.

16. The pressure sensor of claim 14, wherein the second sensing layer and the third electrode are configured to be spaced apart from the first sensing layer in a second direction intersecting the first direction, and
wherein the first sensing layer is configured to, in response to the at least one of the pressure or the temperature, expand in the second direction and contact at least one of the second sensing layer or the third electrode.

17. The pressure sensor of claim 1, wherein the first substrate and the second substrate are made of polyimide or polyethylene terephthalate, and
wherein the first electrode, the second electrode, and the third electrode are made of gold, platinum, silver, or copper.

18. The pressure sensor of claim 17, wherein the first sensing layer and the second sensing layer include conductive particles and a polymer binder.
